(19) United States
(12) Patent Application Publication
(10) Pub. No.: US 2016/0072787 A1
(43) Pub. Date: Mar. 10, 2016

(54) METHOD FOR CREATING SECURE SUBNETWORKS ON A GENERAL PURPOSE NETWORK

(71) Applicants: Igor V. Balabine, Cupertino, CA (US); William G. Friedman, Atherton, CA (US); Ilya G. Minkin, Los Altos, CA (US)

(72) Inventors: Igor V. Balabine, Cupertino, CA (US); William G. Friedman, Atherton, CA (US); Ilya G. Minkin, Los Altos, CA (US)

(21) Appl. No.: 14/852,473

(22) Filed: Sep. 11, 2015

Related U.S. Application Data
(63) Continuation of application No. 11/729,202, filed on Mar. 27, 2007, now abandoned.
Application No. 11/729,202 is a division of application No. 10/358,926, filed on Feb. 4, 2003, now abandoned.
Application No. 10/358,926 is a continuation-in-part of application No. 10/224,098, filed on Aug. 19, 2002, now Pat. No. 7,069,438.

(51) Int. Cl. H04L 29/06; H04W 12/06

(52) U.S. Cl. CPC H04L 63/08; H04L 63/20; H04W 12/06

(57) ABSTRACT

Techniques used in a network that includes non-trusted devices, in which packets of information communicated across the network include network address information for a source device and a destination device of the packets of information are described herein. According to one embodiment, a process of establishing a more secure subnetwork includes inserting at least one credential into at least one packet of information issued by the source device, the credential assessable by a plurality of devices on the network, enabling transmission of the at least one packet of information from the source device to at least one destination device on the subnetwork, assessing the credential by at least one of the devices, and permitting the source device to communicate with the destination device conditioned upon the results of the assessing step. Other methods and apparatuses are also described.

### CROSS REFERENCE TO RELATED APPLICATIONS

This application is a continuation of and claims priority to U.S. patent application Ser. No. 11/729,202, of the same title, filed Mar. 27, 2007, currently pending, which is a divisional of U.S. patent application Ser. No. 10/358,926, filed Feb. 4, 2003, which is abandoned, which is a continuation-in-part (CIP) of U.S. patent application Ser. No. 10/224,098, entitled “Establishing Authenticated Network Connections”, filed Aug. 19, 2002, now U.S. Pat. No. 7,069,438 issued Jun. 27, 2006, which applications/patents are fully incorporated in their entirety by this reference.

### FIELD OF THE INVENTION

The present invention relates to providing network security to networks of any or arbitrary size. In particular, this invention relates to secure subnetworks within a general purpose network.

### BACKGROUND OF THE INVENTION

Most companies today have a strong network perimeter defense in place, and yet damaging attacks occur frequently. Many businesses extend their operations to the Internet, linking together their suppliers, customers, employees and partners. A Web-based front-end allows traditional back-end applications to be accessed from anywhere in the world.

There is a well-understood need to protect the network perimeter and to implement access control between an Intranet and the Internet. IT (information technology) departments can choose from a large arsenal of tools, including ubiquitous firewalls, SSL (secure socket layer), and VPN (virtual private network) solutions. Strong encryption and authentication solutions can be deployed to protect sensitive information as it crosses public networks. However, once the network perimeter has been crossed, as shown in FIG. 1A, the situation changes. Referring to FIG. 1A, sensitive data is often unencrypted and sent from front end servers 601 to middle-tier servers 602 and back-end servers 603 in clear text. Back-end computers often lack adequate means of protecting themselves from network intrusions, and back-end applications are often completely oblivious to security needs. A cyber attacker or a disgruntled employee lurking on the corporate network can easily eavesdrop on the data or mount an attack against servers running critical applications.

Protecting sensitive data and back-end servers inside enterprise networks is a difficult task. Many enterprises deploy legacy systems and applications that lack the means to protect themselves. While VPNs are effective for protecting data sent between isolated networks, they are virtually impossible or impractical to deploy inside existing enterprise Intranets without extensive rewiring, reconfiguration and major disruption of normal operations. FIG. 1B shows a typical example of using VPN to secure an existing network, where networks are partitioned into smaller networks connected by VPN tunnels 606 via VPN gateways 605. However, these VPN gateways are expensive and require complex network reconfiguration, such as rerouting, of the existing network. These requirements often are not feasible to implement in an existing network having legacy applications running at the servers.

### SUMMARY OF THE INVENTION

Techniques used in a network that includes non-trusted devices, in which packets of information communicated across the network include network address information for a source device and a destination device of the packets of information are described herein. According to one embodiment, a process of establishing a more secure subnetwork includes inserting at least one credential into at least one packet of information issued by the source device, the credential assessable by a plurality of devices on the network, enabling transmission of the at least one packet of information from the source device to at least one destination device on the subnetwork, assessing the credential by at least one of the devices, and permitting the source device to communicate with the destination device conditioned upon the results of the assessing step. Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1A illustrates a typical general purpose network;

FIG. 1B illustrates a typical general purpose network with VPN connections;

FIG. 2 illustrates one embodiment of a secure subnetwork;

FIG. 3A illustrates a typical network connection separated by a firewall;

FIG. 3B illustrates one embodiment of a secure network tunnel (SNT);

FIG. 4 illustrates one embodiment of a secure subnetwork;

FIG. 5 illustrates one embodiment of a host having an SNT;

FIG. 6 illustrates an alternative embodiment of a host having an SNT;

FIG. 7 illustrates one embodiment of a process to establish an SNT;

FIG. 8 illustrates one embodiment of an SNT;

FIG. 9 illustrates a layout of a TCP option;

FIG. 10 illustrates an exemplary layout of the TCP authentication option;

FIG. 11 illustrates an alternative layout of the TCP authentication option;

FIG. 12 illustrates a “man-in-the-middle” attack;

FIG. 13 illustrates exemplary information flow during optional fully authenticated three-way TCP handshake;

FIG. 14 illustrates an exemplary layout of the TCP authentication option data in the optional challenge phase;

FIG. 15 illustrates an alternative layout of the TCP authentication option data in the optional challenge phase;

FIG. 16 illustrates an exemplary layout of the TCP authentication option data in the optional response phase;

FIG. 17 illustrates an alternative layout of the TCP authentication option data in the optional response phase;

FIG. 18 illustrates an exemplary layout of the encrypted challenge data when hosts employ public key cryptographic methods;

FIG. 19 shows an exemplary layout of the authentication data when the one-time password method is used for authentication;

FIG. 20 illustrates an authentication process involving a trusted third party authority;

FIG. 21 illustrates one embodiment of an authentication process for a network in which there are one or more intermediary communication nodes; and

FIG. 22 illustrates an exemplary computer which may be used with one embodiment.

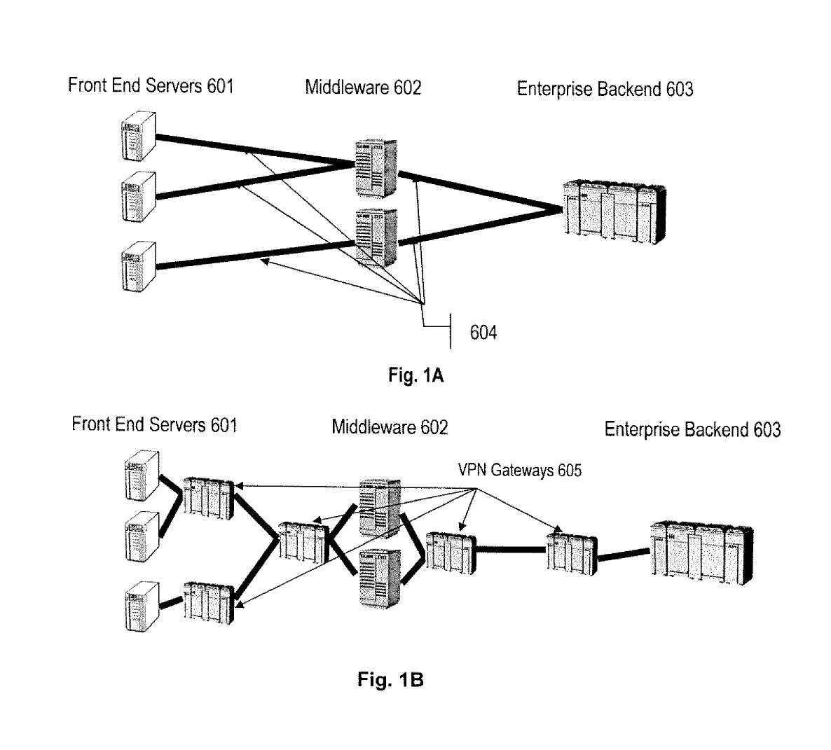

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. In other instances, well-known structures and devices are shown in block diagram form, rather than in detail, in order to avoid obscuring the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “only,” “first,” “initially,” “next,” “subsequently,” “before,” “after,” “lastly,” and “finally,” are not meant to limit the scope of the present invention as the embodiments disclosed herein are merely exemplary.

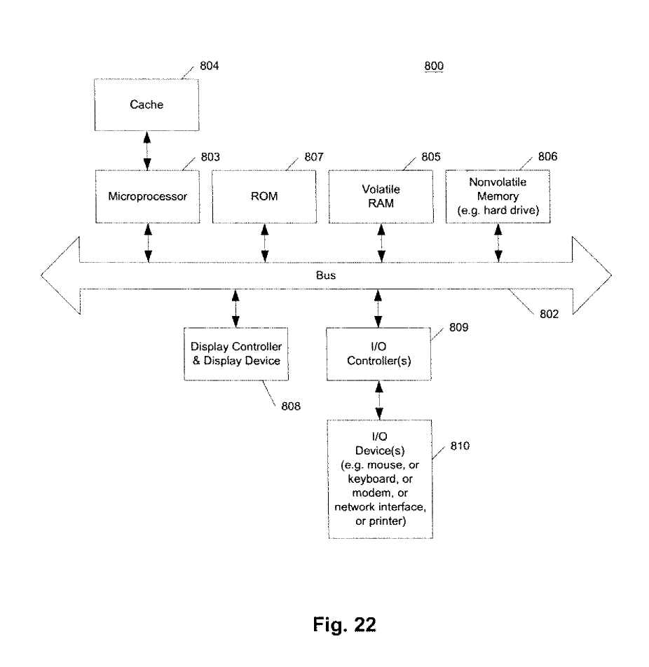

Accordingly, it is desirable to have a lightweight and easy-to-deploy method of creating secure subnetworks inside an existing general purpose network, such as, for example, an intranet or an Internet, without major reconfiguration of the network. Methods and apparatuses for creating secure subnetworks that allow a selection of a subset of hosts deployed on a network, enable protected communications among the hosts, and prevent eavesdropping and unauthorized accesses are described. The term “host” may refer either to a client computer or to a server computer coupled to a network, which may be computer system 800 shown in FIG. 22. According to one embodiment, an exemplary method creates secure encrypted pathways between and/or among the hosts. All network communications between hosts on the protected subnetworks are forwarded along the secure pathways. Each network connection, such as TCP/IP network connections, tunneled through the pathways can be authenticated before the connection is established. Embodiments of the invention are implemented in a kernel space of an operating system (OS) executing with the hosts, such that the protection is transparent to the applications running on the communicating hosts. Embodiments of the invention do not require installing additional hardware and additional network reconfiguration. As a result, embodiments of the invention allow server (e.g., TCP/IP server) concealment and protect a server from establishing unsanctioned connections from both local and remote networks.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

### Overview

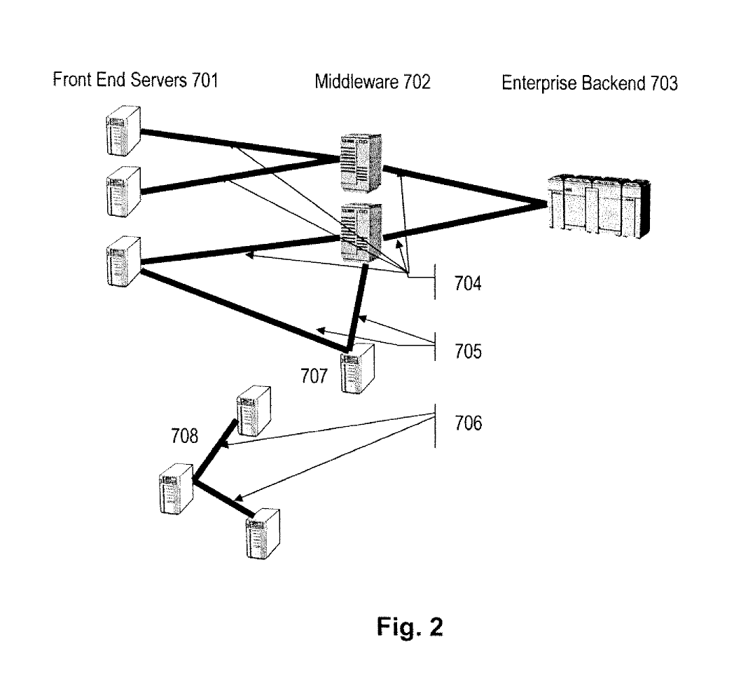

According to one embodiment of the invention, secure network tunnel (SNT) technology creates secure tunnels between peers, also referred to as hosts, connected to unsecured networks. SNT may be based on publicly available technologies such as TLS (transport layer security) and IPSec (Internet protocol security), and/or other proprietary communication authentication schemes. SNT may reside in the TCP/IP (transport control protocol/Internet protocol) stack and allow existing applications to communicate through secure tunnels that may be dynamically established on demand. In one embodiment, no changes in the existing protocols and applications are needed to enable secure communication and no additional security gateway is required, as shown in FIG. 2, for example.

Referring to FIG. 2, the exemplary system includes one or more front end servers 701, middleware servers 702, and enterprise backend servers 703 coupled to each other via one or more secure network tunnels 704. In one embodiment, these servers (e.g., servers 701, 702, and 703), as well as other servers, such as servers 707 to 708, are enterprise servers within a general network, such as an Intranet or an Internet. As discussed above, without the technologies described herein, the connections between these servers are unsecured and unauthenticated connections, which are subject to a variety of attacks from externally (e.g., from Internet) or internally (e.g., within an Intranet).

According to one embodiment, front end servers 701, middleware servers 702, and backend servers 703 are selected to form a subnetwork among a general network, such as an Intranet or an Extranet (e.g., an Internet), which may also include servers 707 to 708. The subnetwork formed by front end servers 701, middleware servers 702, and backend servers 703 is established by connecting these servers through respective secure authenticated tunnels, such as secure tunnels 704. Meanwhile, other connections, such as connections 705 and 706, which connect other unselected servers (e.g., servers 707 and 708) may remain still unsecured and unauthenticated connections, which are subject to attacks externally or internally. In one embodiment, the subnetwork includes the entire general purpose network.

In one embodiment, all data travelling between the servers within the secure subnetwork (e.g., servers 701 to 703) are transmitted via the respective secure and authenticated tunnels. As a result, communications among the servers within the secure subnetwork are protected. Such protected communications prevent eavesdropping and unauthorized accesses.

According to yet another embodiment, each secure connection (e.g., a TCP/IP connection) through the secure tunnel may be authenticated before the connection is established, which will be described in details further below. Data transmitted through the respective secure tunnel connecting the peers may be encrypted according to an encryption algorithm.

According to one embodiment, the secure tunnels may be established by a software program executed within a kernel space of the OS on all selected hosts within the protected subnetwork. As a result, all operations regarding encryption and authentication are transparent to the applications running in a user space. In one embodiment, the software program is embedded in a network driver associated with a network stack, such as the TCP/IP stack of the OS. In a particular embodiment, the software program may be distributed as part of a transport layer of the TCP/IP stack, such that its operations may be transparent to the applications. In addition, since the secure tunnels are implemented through a software program installed at all peers within the subnetwork, no additional hardware (e.g., VPN gateways) and no reconfiguration of the network (e.g., rerouting network traffic through the added VPN gateways) are needed.

According to one embodiment, the SNT are established on demand dynamically. That is, peers establish on-demand secure tunnels when they need to communicate. For example, the original connection between a first peer (e.g., one of the front end servers 701) and a second peer (e.g., one of the middleware servers 702) is an unsecured and unauthenticated connection. When the first peer receives a request for accessing the second peer, the first peer establishes a secure network tunnel with the second peer in response to the request. The secure tunnel may be established statically prior to receiving a request for accessing a host. In one embodiment, the secure tunnels among the peers are established when the peers are in initialization stages (e.g., during booting of the peers). The secure tunnels may be established based on a policy, locally or enterprise wide, governing the connections among the peers. The secure tunnel may be authenticated prior to establishing the connection which is described in details further below. A security policy determines which peers participate in the secure subnetworks and which protocols are tunneled. Any attempt to communicate with a “secured” peer without establishing the protected tunnel may be denied by the software. Technology described herein uses a variety of authentication and encryption techniques and uses enterprise directory services to authenticate participating peers. In one embodiment, the SNT may be governed by an enterprise security policy. Alternatively, the SNT may be governed by a local security policy associated with the host. Furthermore, the enterprise and local security policies may coexist, such that, according to one embodiment, the local security policy may supercede the enterprise security policy.

The SNT may be established using a secure communication protocol, such as SSL or IPSec, etc. The communicating peers involved in the subnetwork may be located on the same network. Alternatively, they may be located on different networks or different networks separated by a firewall. Furthermore, according to one embodiment, the tunneled communications may be performed over a TCP/IP protocol. Alternatively, the tunnel communications may be performed over a UDP, IP, or non-IP protocol.

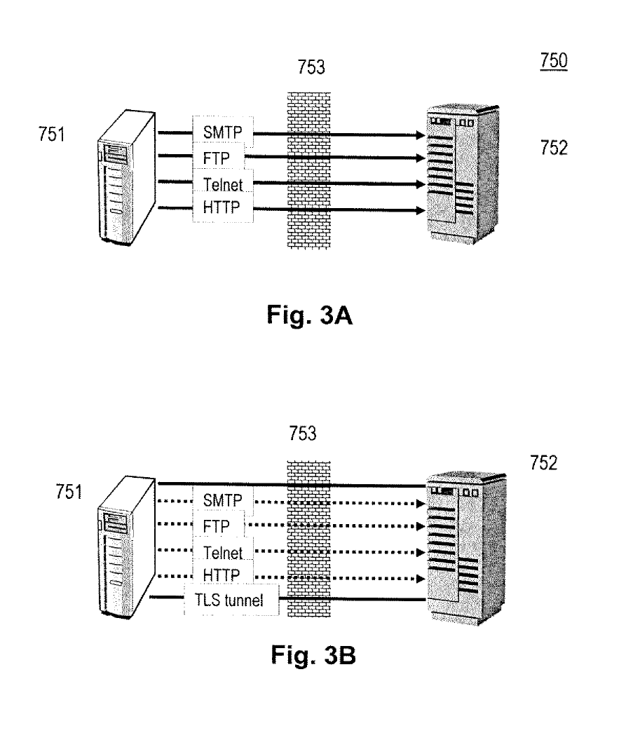

In one embodiment, an SNT deployment may simplify firewall configuration. With SNT deployed, all traffic between two peers can be tunneled though a single authenticated and encrypted connection and thus the technologies described herein can potentially reduce the number of open ports on a firewall. FIG. 3A is a block diagram of a typical firewall configuration without an SNT deployed. As shown in FIG. 3A, peers 751 and 752 are separated by a firewall 753. In order to allow certain protocols, such as SMTP (simple mail transport protocol), FTP (file transport protocol), Telnet, and HTTP (hypertext transfer protocol), to pass through firewall 753, firewall 753 has to open an individual port to accommodate each protocol it supports. However, with the technologies described herein deployed as shown in FIG. 3B, according to one embodiment, the secure tunnel may only open one port to allow one protocol (e.g., TCP protocol) and force all network traffic through the single port and single tunnel. As a result, security has been greatly improved.

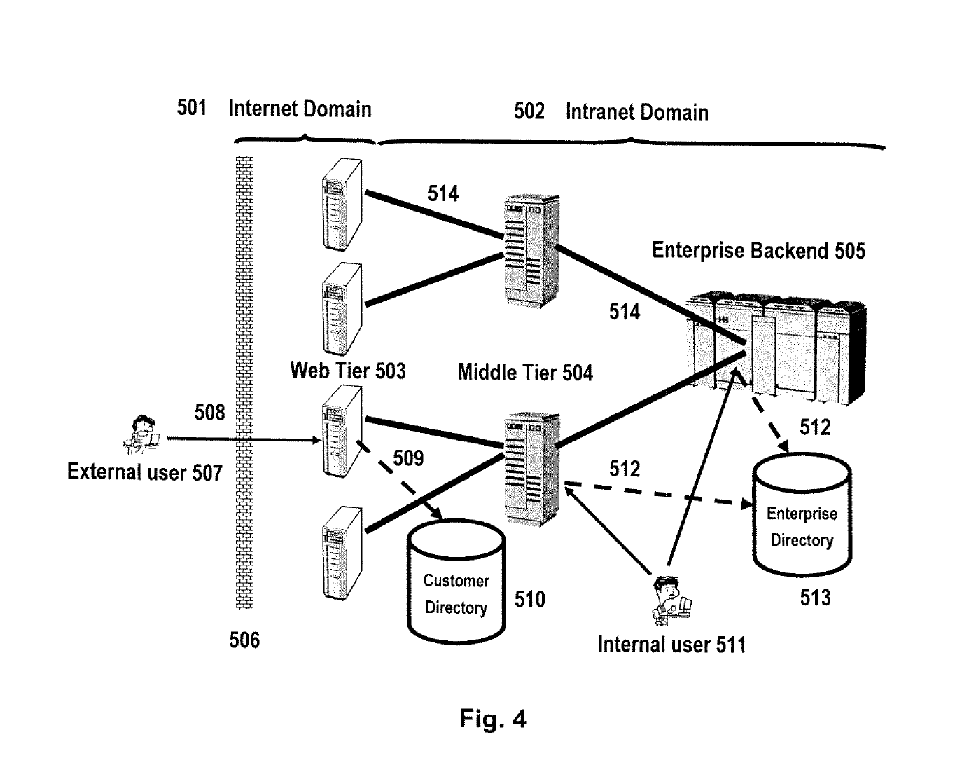

FIG. 4 shows a typical Enterprise Security System (“ESS”) deployment comprised of two security domains: Internet domain 501 and Intranet domain 502. In Internet domain 501 external users 507 are authenticated and authorized to traverse firewall 506 and to use applications in Web tier 503 by a customer directory service 510. A directory service provides a place to store information about network-based entities, such as applications, files, printers, and people. The directory service provides a consistent way to name, describe, locate, access, manage, and secure information about these individual resources. Further, a directory service acts as the main switchboard of the network operating system. The directory service is the central authority that manages the identities and brokers the relationships between these distributed resources, enabling them to work together. Because a directory service supplies these fundamental network operating system functions, the directory service must be tightly coupled with the management and security mechanisms of the operating system to ensure the integrity and privacy of the network. The directory service also plays a critical role in an organization's ability to define and maintain the network infrastructure, perform system administration, and control the overall user experience of a company's information systems. In one embodiment, the network connections may be wireless network connections.

When external user 507 logs into a web application 508, user 507 is authenticated 509 against the customer directory service 510 and her request is allowed to proceed to the applications located in middle tier 504 and at enterprise backend server 505.

Referring to FIG. 4, in Intranet domain 502, internal users 511 are authenticated and authorized to access applications in middle tier 504 and at enterprise backend 505 by internal enterprise directory service 513. When an internal user 511 wishes to use applications in middle tier 504 or at enterprise backend 505 his credentials are passed 512 by the security-aware applications to enterprise directory 513, which authenticates and authorizes internal user 511.

As shown in FIG. 4, in Web tier 503, it is a common practice to authenticate and authorize users 507. However, in a drastic departure from common security principles, in middle tier 504 and at enterprise backend 505, communications are often unauthenticated and unauthorized. This deficiency usually results from the absence of security features built into the legacy mission critical applications deployed at enterprise backend 505 and in middleware applications, such as CORBA (common object request broker architecture) services, located in middle tier 504. Security weaknesses in the applications deployed in middle tier 504 and at enterprise backend 505 could be easily exploited by malicious external 507 or internal 511 users who may break into mission critical applications or eavesdrop on unprotected communications 514.

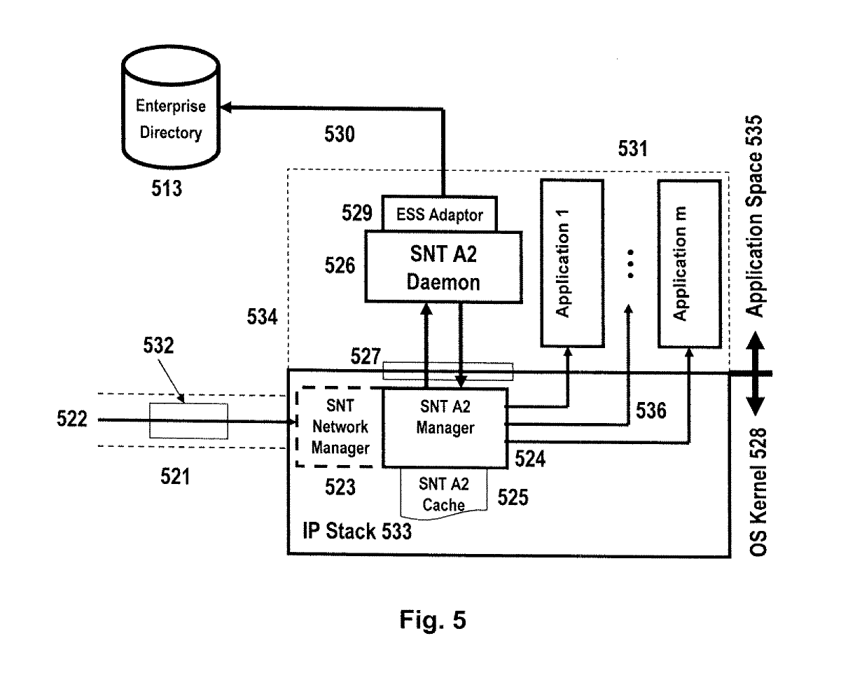

FIG. 5 depicts a block diagram illustrating how an embodiment of SNT module deployed in operating system (OS) Kernel 528 establishes authorizations for network connections for secure tunnel 521 and for tunneled connections 522, employing information from enterprise directory 513. The operating system used in the host may be a Windows operating system from Microsoft Corporation. Alternatively, the operating system may be a Mac OS from Apple Computer, Inc. Furthermore, the operating system may be a Linux, Unix, or VAX/VMS operating system. Other operating systems such as, for example, a real-time operating system or an embedded operating system, may be utilized.

During establishment of authenticated secure tunnel 521 or authenticated tunneled connection 522, a connection request carrying a credential 532 reaches server computer 534. SNT network manager module 523 deployed in operating system IP Stack 533 extracts credential 532 and passes it to the SNT authentication and authorization manager (“A2 Manager”) module 524 via an internal programmatic interface.

In one embodiment, a management module such as SNT A2 Manager 524, who wishes to authenticate and authorize a network connection, communicates with enterprise directory 513 via SNT authentication and authorization daemon (“A2 Daemon”) 526 deployed in application space 535 of server computer 534. The communication between SNT A2 Manager 524 and A2 Daemon 526 occurs over an OS level communications mechanism 527 such as, but not limited to, a shared memory segment, memory mapped file, etc. A2 Daemon 526 picks up the request and forwards it to enterprise directory 513 through a dedicated enterprise security system adapter (“ESS Adapter”) 529. ESS Adapter 529 translates the authentication request of A2 Daemon 526 into the format and protocol 530 understood by enterprise directory 513. Examples of the protocols supported by ESS Adapter 529 used to communicate with enterprise directory 513 include, but are not limited to, LDAP (Lightweight Directory Access Protocol), Active Directory from Microsoft Corporation, OS/390 SAF/RACF/ACF2/Top Secret, etc. Other protocols apparent to those with ordinary skills in the art may be utilized.

Further referring to FIG. 5, upon receiving a response from enterprise directory 513, ESS Adaptor 529 translates it into internal SNT A2 Daemon 526 format. A2 Daemon 526 then passes the authorization response to A2 Manager 524 via OS level communications mechanism 527.

Depending on enterprise directory 513 responses, A2 Manager 524 makes a decision as to whether to allow establishment of a secure tunnel 521, or to allow a network connection 536 to Application 531, or to deny network communications request 522. A2 Manager 524 may make its decision to allow or to deny the communications request based on a local policy optionally superimposed on a policy provided by enterprise directory 513. For example, enterprise wide system administrator may set up an enterprise policy, which may be included in an enterprise directory service (e.g., enterprise directory 513 of FIG. 4), that all hosts involved in the secure subnetwork may only accept certain protocols, such as SMTP, FTP, Telnet, and HTTP, because the hosts are serving as servers specifically for those protocols. However, an individual host or server may only operate for a specific function, such as a mail server. As a result, a local administrator may set up a local policy, which may be included in a local customer directory service (e.g., customer directory 510 of FIG. 4), to limit the respective server to only accept SMTP protocol. As a result, security of an individual host has been further improved.

In the case of a positive enterprise directory 513 response, the A2 Manager optionally adds a record about a newly established network connection 522 to SNT authentication and authorization cache (“A2 Cache”) 525. A2 Manager 524 may support arbitrary authorization models including, but not limited to, RBAC (role based access control) or DAC (discretionary access control). Other models apparent to those of ordinary skill in the art may be utilized.

According to one embodiment, A2 Cache 525 is policy-driven and it allows the retention of temporary authentication and authorization information about established connections. The connection information is stored in the A2 Cache for a limited time or a maximal number of accesses, as determined by a local policy. Once the policy limits are exceeded, the corresponding cache entry is flushed and Enterprise Directory 513 again is accessed to authorize the next peer's communication request 522. Being local to A2 Manager 524, A2 Cache 525 significantly reduces the time required to receive authentication and authorization information without endangering communications security.

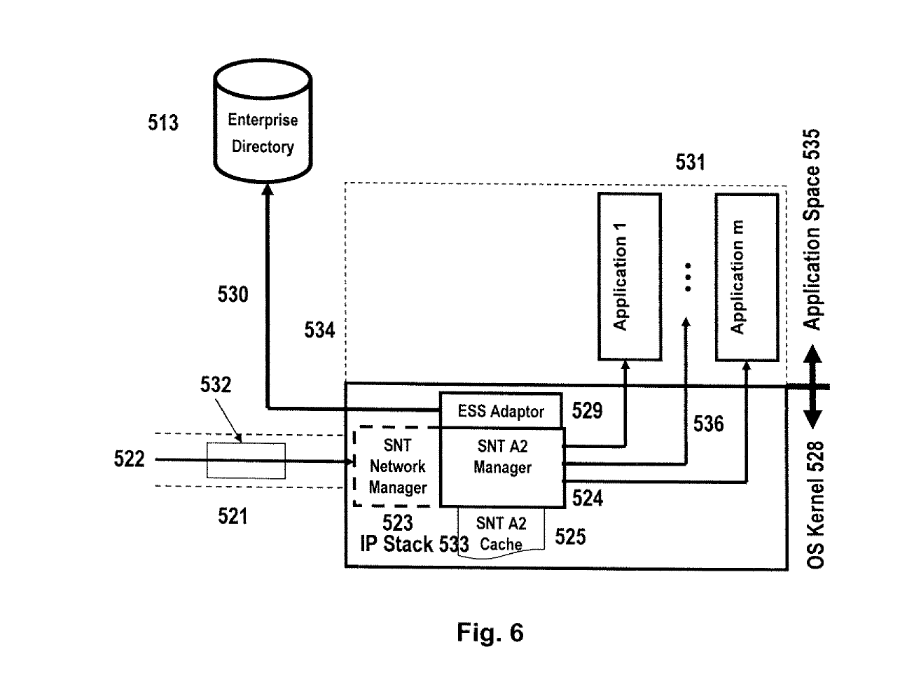

FIG. 6 is a block diagram of an alternative embodiment illustrating how ESS Adapter 529 is deployed in OS Kernel 528, and SNT A2 Manager 524 communicates with ESS Adapter 529 directly rather than through an intermediary. ESS Adapter 529 communicates with Enterprise Directory 513 in the same fashion as described above.

SNT technology offers a wide variety of network connection authentication and protection capability. In one embodiment all requests for TCP/IP network connections between the communicating peers are authenticated before connection is permitted, which will be described in details further below.

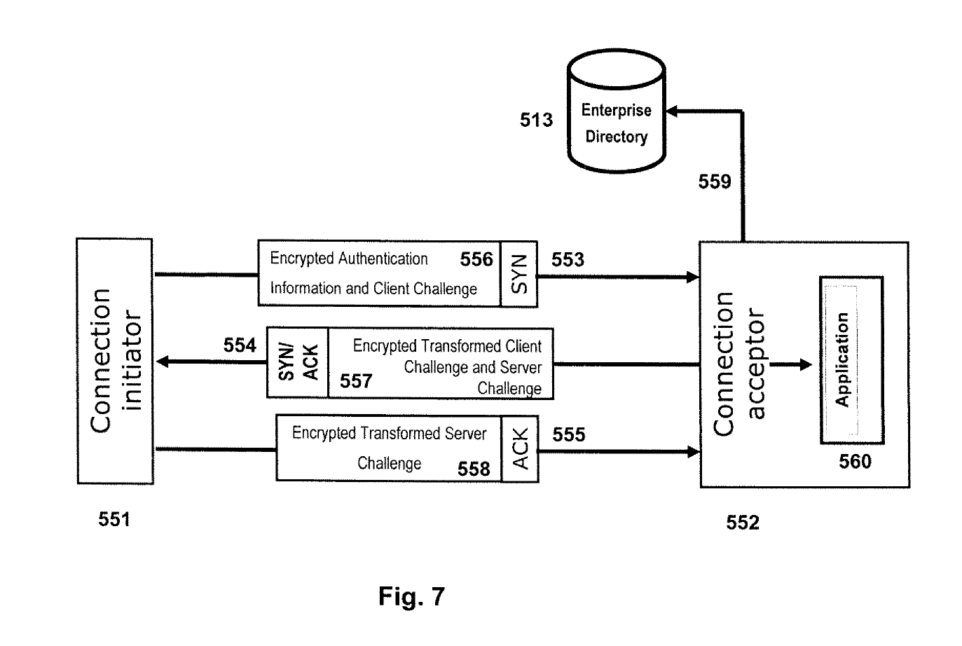

FIG. 7 is a block diagram illustrating an embodiment of a process for establishing a mutually authenticated TCP/IP connection, which may be used to establish an SNT tunnel. According to one embodiment, connection initiator 551 sends a TCP/IP connection request SYN packet 553 to connection acceptor 552. SYN packet 553 contains connection initiator's 551 identity and encrypted authentication information 556, which identifies connection initiator 551. It also contains the connector initiator's challenge value for connection acceptor 552.

Connection acceptor 552 communicates with enterprise directory 513 to authenticate connection initiator 551 using her identity and authentication information 556 found in SYN packet 553. If authentication is successful, connection acceptor 552 decrypts connection initiator's 551 challenge. Connection acceptor 552 then transforms it, adds its own challenge and encrypts both values. Connection acceptor 552 then passes authentication payload 557 to connection initiator 551 in TCP/IP SYN/ACK packet 554. Connection initiator 551 decrypts its own transformed challenge value and after making sure that it is correct, transforms and encrypts connection acceptor's 552 challenge value and passes it back to connection acceptor 552 in TCP/IP ACK packet 555. Connection acceptor 552 decrypts and verifies connection initiator's 551 response 558 and hands off the newly established connection to destination application 560. It will be appreciated that pre-connection authentication may be applied to the establishment of tunneled network connections and to the establishment of the secure tunnel, itself.

In an alternative embodiment, referring to FIG. 7, network connections established between communicating peers are authenticated unidirectionally. For example, connection initiator 551 authenticates to connection acceptor 552, or is not authenticated at all. In this embodiment, security of connection is achieved through the properties of the secure tunnel.

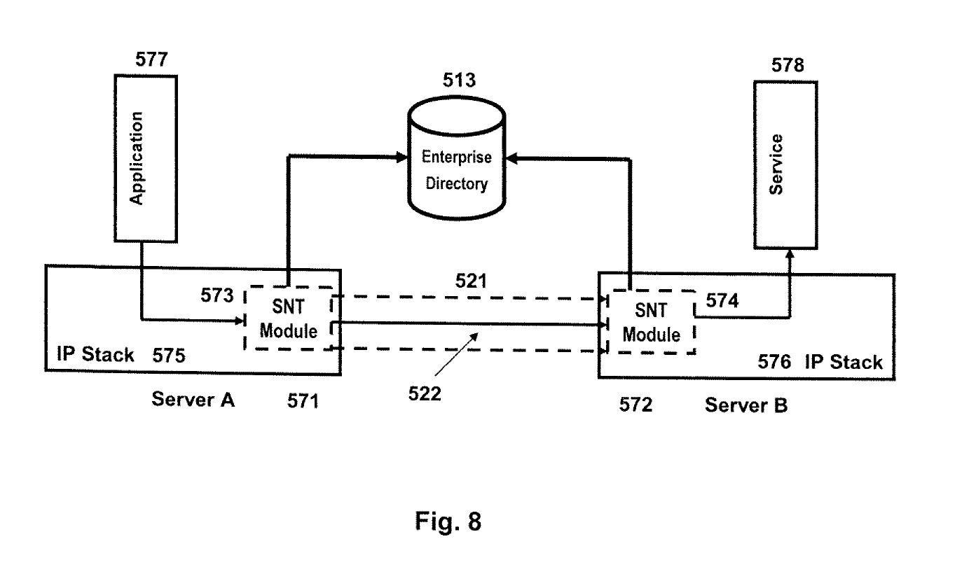

FIG. 8 is a block diagram illustrating an embodiment of an SNT. According to one embodiment, an exemplary secure tunnel 521 is established between SNT modules 573 and 574 which are deployed in IP stacks 575 and 576 of communicating Server A 571 and Server B 572. In this embodiment, secure tunnel 521 was requested by SNT module 573 on behalf of potentially security-unaware application 577, which requested a communication with an SNT-protected service 578. SNT module 574, which is deployed in IP Stack 576 of server 572 and hosts desired service 578, accepted secure tunnel 521.

Initiating SNT module 573 and accepting SNT module 574 establish a secure tunnel 521 depending on the security policy set forth at an enterprise directory. Initiating SNT module 573 may optionally superimpose its own non-contradictory local policies such as, but not limited to, allowing only certain accounts on server 571 to establish tunneled connections 522 to server 572.

Secure tunnel 521 can be established by using the SSL/TLS protocol or a variant of it such as WTLS (wireless transport layer security), the IPSec protocol or other communications protocols, which support encrypted communications. Initiating SNT module 573 and accepting SNT module 574 may negotiate a protocol for secure tunnel 521 using the EAP (extensible authentication protocol). Other protocols may be utilized.

During establishment of secure tunnel 521, initiating SNT module 573 and accepting SNT module 574 unidirectionally or mutually authenticate each other via enterprise directory 513. Secure tunnel 521 can be negotiated by the communicating parties without any authentication using, for example, but not limited to, a Diffie-Hellman key agreement method. Secure tunnel 521 can also be established as requiring only message integrity verification and without the privacy property. Application 577 and service 578 can be communicating through secure tunnel 521 using, for example, TCP/IP protocol, UDP protocol, or any other protocols, such as non-IP based network protocols.

According to one embodiment, secure tunnel 521 may be established dynamically on demand. For example, when SNT module 573 receives a request from application 577 to access service 578 located on server 572, SNT module 573 may check whether secure tunnel 521 has been previously established. If SNT 521 has not been established, SNT module 573 may try to establish an SNT with SNT module 574 of server 572. In one embodiment, SNT modules 573 and 574 may mutually authenticate with each other prior to establishing the connection. In addition, SNT modules 573 and 574 may inspect the request originating from application 577 to determine whether such request should be entitled for service 578 via enterprise directory 513. Once SNT tunnel 521 has been established, SNT module 573 may encrypt data received from application 577 and transmit the data to server 572 via SNT 521. It is appreciated that all operations performed by SNT module 573 are performed in a kernel space of the OS executed within server 571, such that the operations are transparent to application 577. In one embodiment, application 577 may be a security-unaware application (e.g., a legacy application). However, the data exchanged between servers 571 and 572 are transmitted via SNT tunnel 521 which are not feasible to attack by an intruder.

According to one embodiment, when SNT module 574 receives an encrypted data from SNT module 573, SNT module 574 may inspect the encrypted data to determine whether such data has been transmitted from a trusted peer via a secure tunnel. The inspection may be performed against enterprise directory 513 services. Note that server 572, which has an SNT with server 571, may also have other connections (e.g., unsecured connections) with other hosts (e.g., non-members of the subnetwork). Once SNT module 574 determines that the data is received from SNT module 573, it decrypts the encrypted data according to an agreed upon encryption/decryption algorithm which may be stored in enterprise directory 513. Thereafter, SNT module 574 transmits the decrypted data to the designated application 578, which may be a security unaware application. It is appreciated that all operations performed by SNT module 574 are performed in a kernel space of the OS executed within server 572, such that the operations are transparent to application 578.

Note that SNT modules 573 and 574 are software programs, which may be installed on all hosts constituting the secure subnetwork within a general purpose network, such as an Intranet. The software package including SNT modules 573 and 574 may be distributed and installed by an enterprise wide system administrator. The software package may be installed in addition to an existing network stack of an operating system. That is, when the software package is installed, it “hooks” on the network stack, such as TCP/IP stack, such that the SNT modules may intercept the network traffic (e.g., outgoing and incoming traffics) within the network stack. Then the SNT modules may perform any necessary operations including, but not limited to, authenticating the request against a directory service, establishing an SNT tunnel with a destination host if it has not been established, encrypting outgoing packets, and decrypting incoming packets, etc. In one embodiment, such operations are completely transparent to the respective applications and do not require any changes at the application level. In one embodiment, the software package may be uninstalled and the original network stack may be restored without the knowledge of the respective applications. Other configurations may be utilized.

### Establishment of Authenticated Network Connections

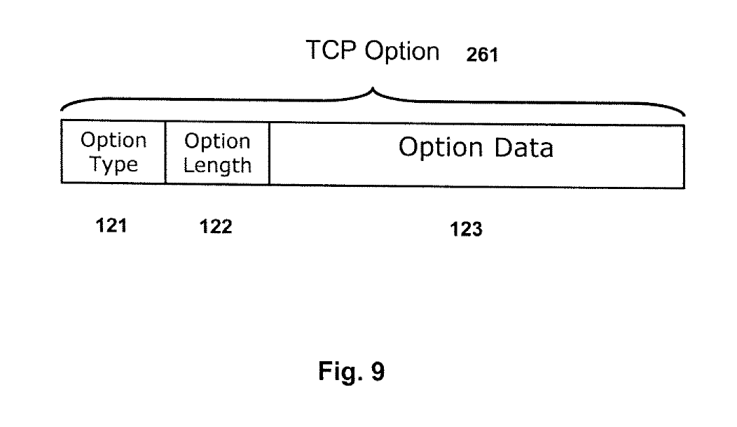

FIG. 9 is an exemplary layout of a TCP option field within a TCP header in accordance with the TCP/IP protocol, which may be used in SYN packet 553, SYN/ACK packet 554, and ACK packet 555 of FIG. 7, to establish an authenticated connection prior to establishing a connection with a host. TCP option 261 consists of option type octet 121, option length octet 122, and option data 123. In one embodiment, TCP option 261 is padded to a multiple of 4 octets by a “No Operation” TCP option.

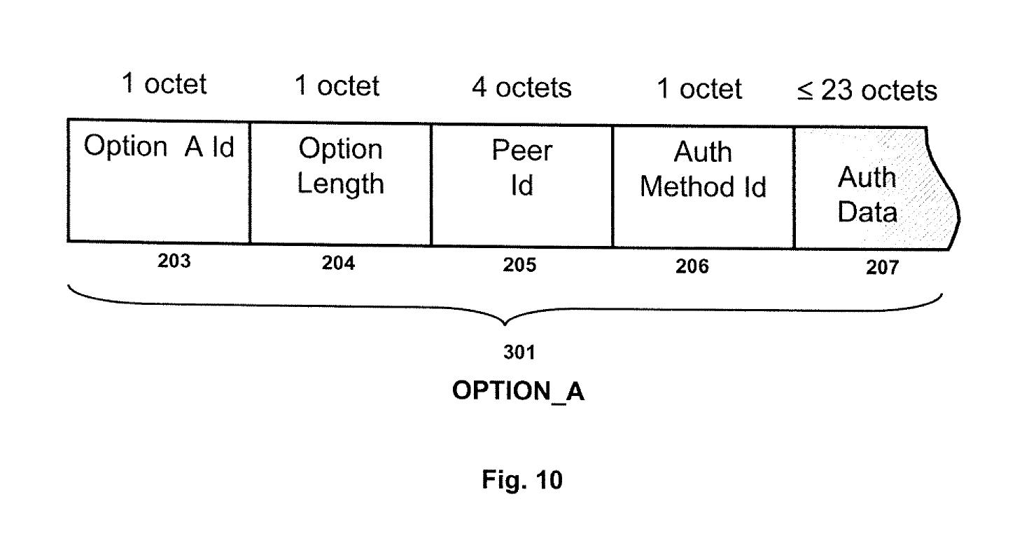

In order to selectively prevent the establishment of unauthorized TCP/IP connections, novel measures are taken. FIG. 10 illustrates a single instance of a special TCP option 261, OPTION_A 301, that is added to SYN packet 553. In one embodiment, OPTION_A 301 is comprised of an octet which contains the option A ID 203; an octet containing option length 204; and followed immediately by four octets containing peer Id 205 of a client computer at a server computer site. The octet following peer ID 205 contains a unique identifier of the authentication method, auth method ID 206, which is used to authenticate the client computer.

Octets following auth method ID 206 contain authentication data, auth data 207. In one embodiment, auth data 207 length is limited to approximately 23 octets due to the size limitation of the TCP header.

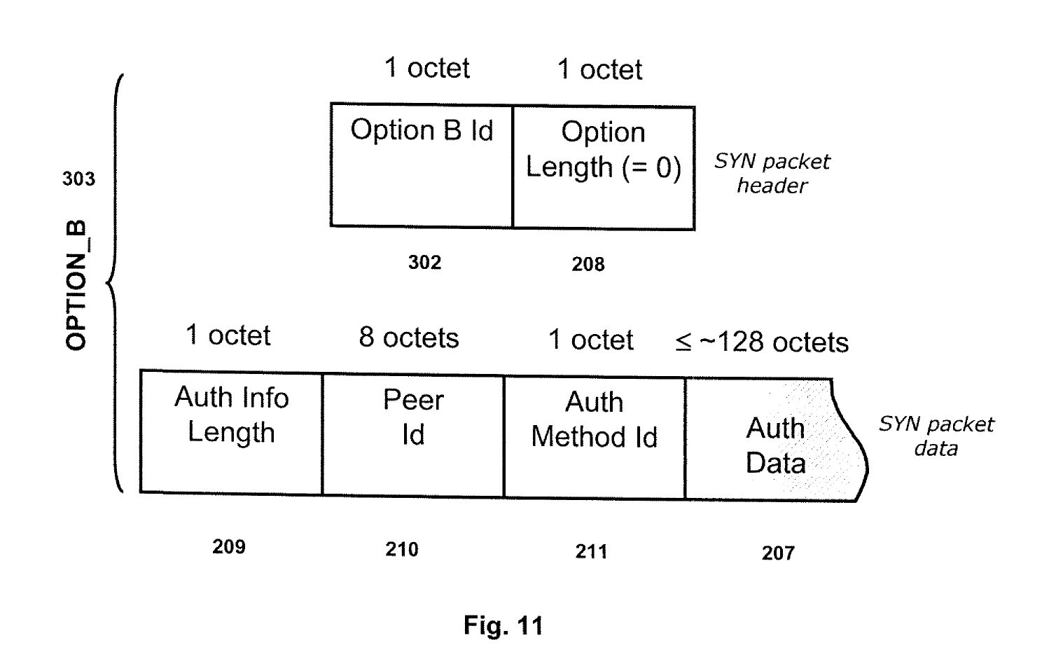

In another embodiment, as illustrated on FIG. 11, a single instance of a special TCP option 261, OPTION_B 303, is added to SYN packet 553. In one embodiment, OPTION_B 303 is comprised of an octet that contains the option B ID 302 and option length 208 octet set to zero, indicating that length of the following TCP option 261 data is 0.

When OPTION_B 303 is used, authentication information is placed in the data portion of SYN packet 553. Authentication information begins with a single octet auth info length 209 containing total length of the peer ID 210, auth method ID 211 and auth data 207 fields. This octet is followed immediately by eight octets containing peer ID 210 for the client computer at the site of server computer. The following octet, auth method ID 211, contains a unique identifier of the authentication method used to authenticate the client computer by the server computer. Octets following auth method ID 211 contain authentication data in auth data 207. In one embodiment, auth data 207 length is limited to approximately 128 octets due to the data size limitation of the TCP/IP packet.

Sending a SYN packet to a TCP/IP server is not the only method to discover a network service. Activity in which a party tries to locate services available on a network is called “scanning”. Typically, scanning is performed by sending SYN packets to the ports of the hosts deployed on the network. This type of scanning is called “SYN-scan”.

In addition to SYN-scan, a sophisticated attacker can utilize FIN, ACK or NULL scans. These scans send an unsolicited packet with the respective TCP flag set, as denoted by the name of the scan. Packets sent during these scans are not a part of any valid established TCP connection. The TCP/IP protocol requires the host that receives one of those packets to generate a response, an RST packet, if the TCP port was closed, and to ignore the packet if the TCP port was open. This behavior, prescribed by the TCP/IP protocol standard, allows the attacker to determine which TCP ports are open on a target Host.

In order to prevent open TCP port detection by FIN, ACK or NULL scans, in one embodiment, the server computer tracks all established TCP connections. The host computer generates an RST Packet in response to any packet sent to an open TCP port that does not belong to a valid TCP connection. Providing the same response to packets sent to an open TCP port and to a closed TCP port denies an attacker any useful information.

Before attempting the establishment of an authenticated TCP/IP connection, the client computer and the server computer agree on the type of authentication method that they will use for authentication purposes. Various embodiments include, but are not limited to, the following authentication methods:
cryptographic hashed message authentication code (HMAC);
cryptographic hash with timestamp;
one time password;
public key cryptography-based;
based on security assertion provided by a trusted third party.

Each of these authentication methods includes a variation that introduces additional authentication steps designed to prevent the “man-in-the-middle” (MITM) attacks against the protected server computer.

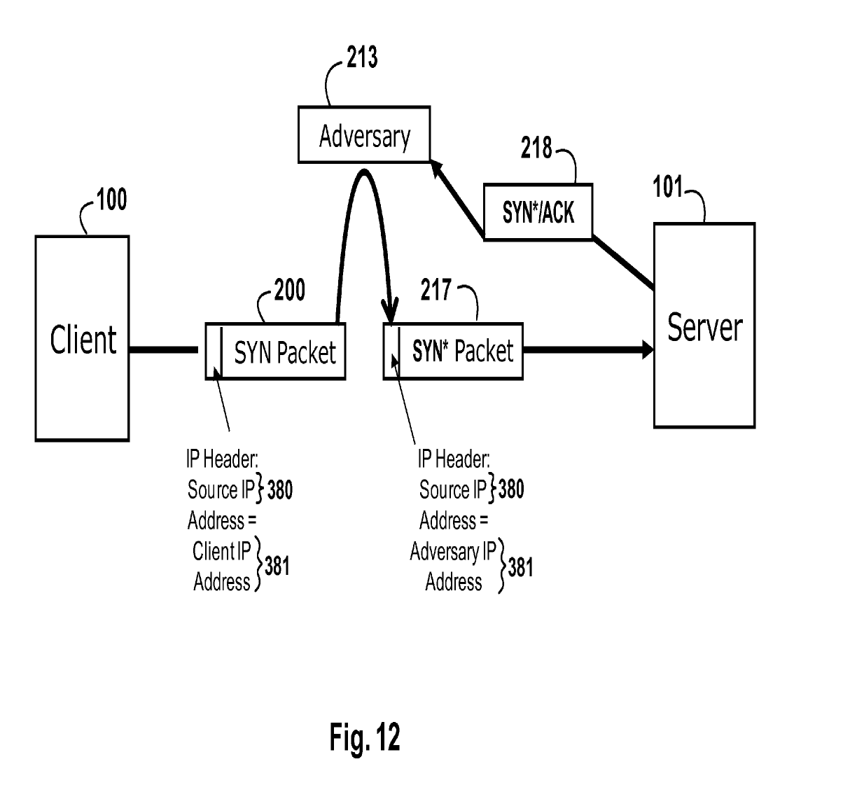

As illustrated in FIG. 12, a powerful adversary 213 may position itself on the network on the route of TCP/IP connection initiation, and modify SYN packet 200 sent by client computer 100 to server computer 101. Adversary 213 is capable of changing the original source address 381 field value in the IP header 380 of SYN packet 200 to the adversary's IP address.

As a consequence of such action by adversary 213, upon receiving the amended SYN* packet 217, server computer 101 verifies authentication data in the amended SYN* packet 217 if that authentication data did not include a cryptographically protected reference to the IP address of client computer 100. Given the fact that in a large number of deployments, the source IP address cannot be verified due to the widespread use of Network Address Translation (NAT) technology by network perimeter devices, an MITM (man in the middle) attack could be successfully staged by adversary 213.

A successful MITM attack against server computer 101 forces it to send a response SYN*/ACK packet 218 to adversary 213 instead of to client computer 100. As a result, server computer's TCP/IP session is diverted to adversary 213.

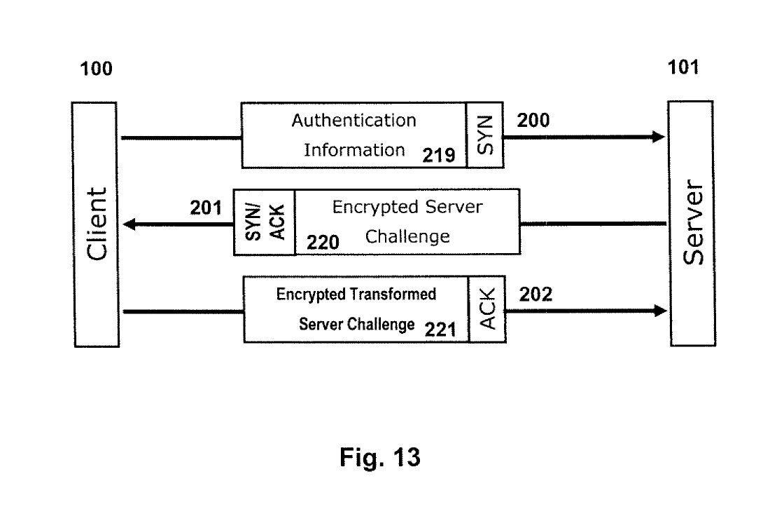

Special variations of the authentication methods include provision for a challenge response exchange between client computer 100 and server computer 101 to further verify the source of the nascent TCP/IP session prior to the establishment of any connection. As illustrated in FIG. 13, upon receiving the SYN packet 200 with authentication information 219, server computer 101 uses a shared secret key or a public key of the client computer 100 to encrypt a randomly generated octet sequence, i.e. the challenge. Server computer 101 places the challenge in the response SYN/ACK packet 201 and sends it to client computer 100. Upon receiving the SYN/ACK packet 201, client computer 100 decrypts the challenge using the shared secret key or a private key, transforms it according to an established algorithm, and encrypts it with the shared secret key or with the public key of server computer 101. Next, client computer 100 sends an encrypted transformed challenge back to server computer 101 in the ACK packet 202 with encrypted transformed server challenge 221. Upon receiving ACK packet 202 with encrypted transformed server challenge 221, server computer 101 decrypts the transformed challenge and verifies that client computer 100 transformed the challenge correctly.

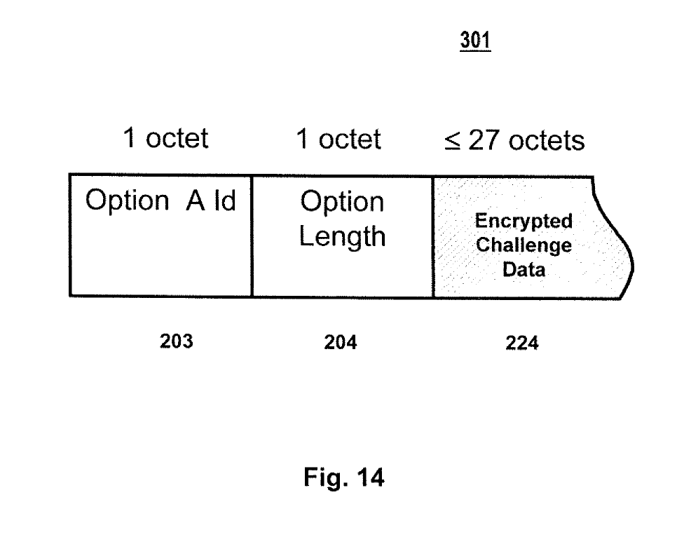

FIG. 14 shows one embodiment of the challenge data layout in the SYN/ACK packet 201 sent by server computer 101 to client computer 100. A single instance of a special TCP option 261, OPTION_A 301, is added to SYN/ACK packet 201. In one embodiment, OPTION_A 301 is comprised of an octet that contains option A ID 203, followed by an octet indicating the length of the following TCP/IP option 261 data, option length 204. Encrypted challenge information, encrypted challenge data 224, immediately follows option length 204. The length of encrypted challenge data 224 depends on the type of authentication algorithm in use. In one embodiment, authentication data length is limited to approximately 27 octets due to the size limitation of the TCP header.

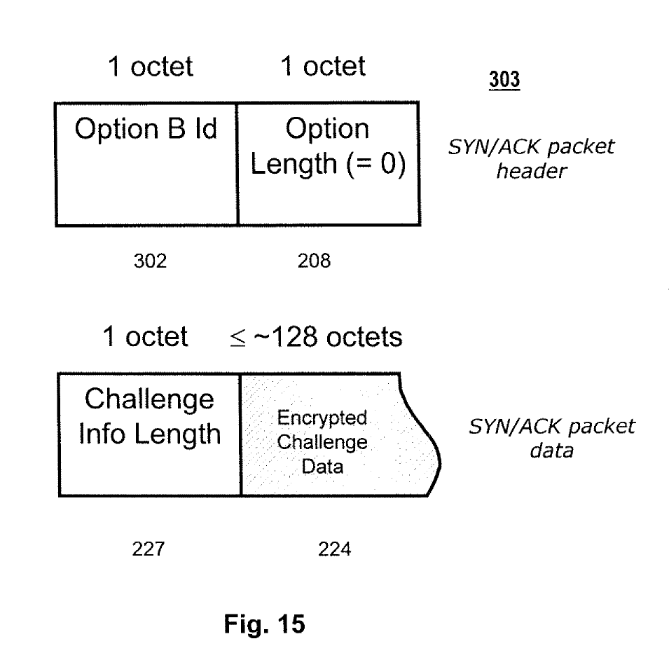

In another embodiment, as illustrated on FIG. 15, a single instance of a special TCP option 261, OPTION_B 303, is added to SYN/ACK packet 201 sent by server computer 101 to client computer 100. In one embodiment, OPTION_B 303 is comprised of an octet that contains option B ID 302, followed by a zero octet, option length 208, which indicates that length of the following TCP/IP option 261 data is 0. When OPTION_B 303 is used, encrypted challenge information is placed in the data portion of SYN/ACK packet 201.

Encrypted challenge information begins with a single octet, challenge info length 227, containing the length of the following encrypted challenge information. Octets following challenge info length 227 contain encrypted challenge data 224. In one embodiment, challenge data length is limited to approximately 128 octets due to the size limitation of the TCP/IP packet data size.

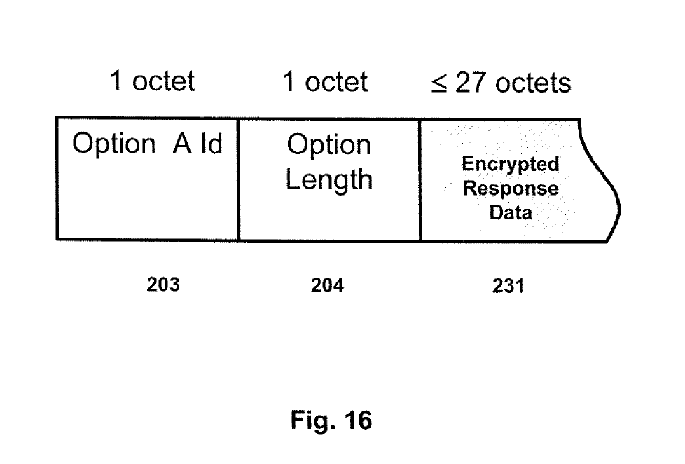

FIG. 16 shows one embodiment of the response data layout in the ACK packet 202 sent by client computer 100 to server computer 101. A single instance of a special TCP option 261, OPTION_A 301, is added to ACK packet 202. In one embodiment, OPTION_A 301 is comprised of an octet that contains the option A ID 203, followed by an octet indicating the length of the following TCP/IP option 261 data, option length 204. Encrypted response information, encrypted response data 231, immediately follows option length 204. The length of encrypted response data 231 depends on the type of authentication algorithm in use. In one embodiment, authentication data length is limited to approximately 27 octets due to the size limitation of the TCP header.

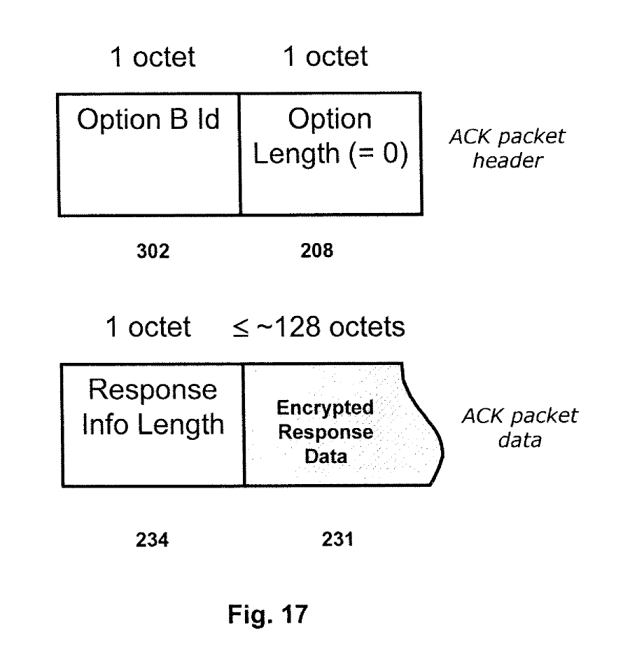

In another embodiment, as illustrated on FIG. 17, a single instance of a special TCP option 261, OPTION_B 303, is added to ACK packet 202 sent by client computer 100 to server computer 101. In one embodiment, OPTION_B 303 is comprised of an octet that contains option B ID 302, followed by a zero octet, option length 208, which indicates that length of the following TCP/IP option 261 data is 0. When OPTION_B 303 is used, encrypted response information is placed in the data portion of ACK packet 202.

Encrypted response information begins with a single octet, response info length 234, containing the length of the following encrypted response information. Octets following response info length 234 contain encrypted response data 231. In one embodiment, challenge data length is limited to approximately 128 octets due to the size limitation of the TCP/IP packet data size.

When hosts use a secret key-based authentication method, server computer 101 generates an 8 octet long random value, Salt, concatenates it with a shared secret key value, Secret, and with the sequence number field, Seq#, from the TCP header in SYN packet 200 sent by client computer 100. Server computer 101 applies a secure hash cryptographic algorithm (e.g., MD5, SHA-1, etc.) to the resulting octet sequence, thus generating a challenge value, Ch:

Ch=H(Salt|Secret|Seq#)

Then server computer 101 concatenates the Salt value and the challenge value, Salt|Ch, and places the result in encrypted challenge data 224 field of SYN/ACK packet 201.

Upon receiving the challenge, client computer 100 verifies that the challenge value, Ch, was indeed sent by server computer 101 by locally recalculating that value. In order to create a response, client computer 100 concatenates the received challenge value, Ch, with the shared secret value, Secret, and computes a secure cryptographic hash of the result, e.g. MD5 or SHA-1:

H(Ch|Secret)

Client computer 100 places the computed response value in encrypted response data 231 field of the ACK packet 202. Upon receiving ACK packet 202, server computer 101 verifies the response value computed by the client computer 100.

Server computer 101 selects a secure cryptographic hash algorithm according to its local policy. Client computer 100 determines the type of secure cryptographic hash algorithm used by server computer 101 from the value found in the option length 204 field if OPTION_A 301 layout is used (e.g., 16 octets for MD5, 20 octets for SHA-1). If OPTION_B 303 layout is used, then client computer 100 determines the secure cryptographic hash algorithm used by server computer 101 from the value found in the challenge info length 227 field (e.g., 16 octets for MD5, 20 octets for SHA-1). To calculate the response value, client computer 100 must use the same secure cryptographic hash algorithm as is used by server computer 101 when it calculates the challenge value.

When hosts employ public key cryptography-based authentication methods, server computer 101 generates a 12 octet-long random value, Rand, concatenates it with the sequence number field, Seq#, from TCP header 113 in the SYN packet 200 sent by client computer 100, Ch=Rand|Seq#, and encrypts it with server computer 101 private key, Pr v^{S}:

E_{Prv}_{^{S}}(Ch)

Server computer 101 places the result in encrypted challenge data 224 of SYN/ACK packet 201.

Upon receiving the challenge, client computer 100 decrypts the challenge value using server computer 101 public key, Pub^{S}:

Ch=D_{Pub}_{^{S}}(E_{Prv}_{^{S}}(Ch))

Client computer 100 verifies that the challenge, Ch, was indeed computed by server computer 101 by comparing the value of the Seq# with the sequence number value found in sequence number field as sent by client computer 100 to server computer 101 in SYN packet 200.

After verifying the origin of the challenge value, client computer 100 encrypts the received challenge value, Ch, with client computer 100 private key, Pr v^{C}:

E_{Prv}_{^{C}}(Ch)

Client computer 100 places the computed response value in encrypted response data 231 field of ACK packet 202.

Upon receiving ACK packet 202, server computer 101 decrypts the value in encrypted response data 231 field of ACK packet 202 using client computer 100 public key, Pub^{C}:

Ch=D_{Pub}_{^{C}}(E_{Prv}_{^{C}}(Ch))

Server computer 101 verifies client computer 100 response by comparing the decrypted Rand value with the random value which it sent to client computer 100 in SYN/ACK packet 201.

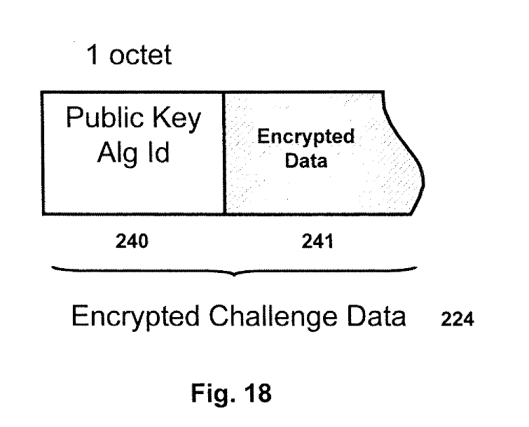

FIG. 18 illustrates the structure of encrypted challenge data 224 field. The public key alg ID 240 octet contains a numeric identifier of a public key cryptographic algorithm used to encrypt challenge data in encrypted data 241 field that follows. The choice of public key cryptographic algorithm depends on server computer's 101 policy. In one embodiment, server computer 101 can choose, without limitation, to use original (e.g., RSA) or ECC (Elliptic Curve Cryptography) based versions of public key encryption algorithms. In one embodiment, hosts follow the PKCS#1 (Public Key Cryptography Standards #1) guidelines when performing original RSA public key encryption. The hosts follow the ANSI X9.62 ECDSA (Elliptic Curve Digital Signature Algorithm) guidelines for the ECC variants of the public key encryption.

As described above, SYN packet 200 contains cryptographically secured data that authenticates client computer 100 to server computer 101. Following are descriptions of various embodiments that are meant to be illustrative, which do not exclude other embodiments of this invention.

Hashed Message Authentication Code (HMAC) is an authentication method that may be used to authenticate client computer 100 to server computer 101. HMAC of SYN packet 200 is computed by concatenating the shared secret key, Secret, with values found in the following fields: source IP address, SrcIPAddr, destination IP address, DestIPAddr, source port number, SrcIPort#, Destination Port Number, DestPort#. In one embodiment, the HMAC computation is performed according to the guidelines found in the IETF RFC 2104 “HMAC: Keyed Hashing For Message Authentication” document (“RFC2104”):

HMAC(SrcIPAddr|DestIPAddr|SrcIPPort|DestIPPort|Secret)

Server computer 101 verifies the HMAC using data in SYN packet 200 sent by client computer 100.

In another preferred embodiment, a different authentication method may be used to authenticate client computer 100 to server computer 101, which is based on a timestamp provided by a trusted third party such as a NTP (Network Time Protocol) server. Client computer 100 concatenates a decimal ASCII value of the NTP timestamp, T_{C}, with the shared secret key, Secret, and, in one embodiment, computes a cryptographic hash value according to the guidelines found in the RFC2104:

H=HMAC(T_{C}|Secret)

Client computer 100 concatenates the timestamp, T_{C}, with the HMAC value, H, T_{C}|H, and sends it to server computer 101.

Upon receiving SYN packet 200 from client computer 100, server computer 101 verifies the HMAC value and, if successful, obtains a NTP timestamp, T_{S}, from a trusted server. Server computer 101 compares the trusted timestamp value, T_{S}, with the timestamp value received from client computer 100, T_{C}, and if the value of the timestamp value received from client computer 100, T_{C}, is within the window allowed by server computer 101 policy, Δ, |T_{C}−T_{S}|≦Δ, server 101 computer accepts the communications session.

In yet another preferred embodiment, the authentication method used to authenticate client computer 100 to server computer 101 is based on one-time password technology. Prior to establishing the first authenticated TCP/IP session, client computer 100 and server computer 101 agree on a pair of publicly known non-zero values, Salt₀, and TrfCount₀ (where TrfCount₀<256). Client computer 100 and server computer 101 also use another publicly known value, SeqCnt, which initially is set to zero.

In order to compute the next one-time password value, both client computer 100 and server computer 101 concatenate the Salt₀ value and the shared secret key, Secret, and computes its HMAC TrfCount₀ times:

OTP₀=HMAC^{TrfCount}^{₀}(Salt₀|Secret)

To calculate the next one-time password value, OTP₁, both client computer 100 and server computer 101 subtract one from the TrfCount₀ value. If TrfCount₀−1=0, the host (client computer 100 or server computer 101) calculates Salt₁ value as:

Salt₁=HMAC(Salt₀|Secret)

The host also computes the next maximal transformation counter value, TrfCount₁, as:

TrfCount₁=HMAC(Salt₁|Secret)_{mod 256}

If TrfCount₁=0, the HMAC is calculated again:

TrfCount₁=HMAC(HMAC(Salt₁|Secret))_{mod 256}

This calculation continues until a non-zero value for TrfCount₁ is obtained. Once a new value of the maximal transformation counter is computed, the host (client computer 100 or server computer 101) increments the SeqCnt value by one.

In order to thwart replay attacks, the host (client computer 100 or server computer 101) which verifies a one-time password value ensures that the sequence counter value, SeqCnt_{C}, submitted by the claimant is greater or equal to the locally known sequence counter value, SeqCnt_{V}, and that the transformation counter value, TrfCount_{C}, submitted by the claimant is less or equal than the locally known transformation counter value, TrfCount_{V}:

SeqCnt_{C}≧SeqCnt_{V} and TrfCount_{C}≦TrfCount_{V}

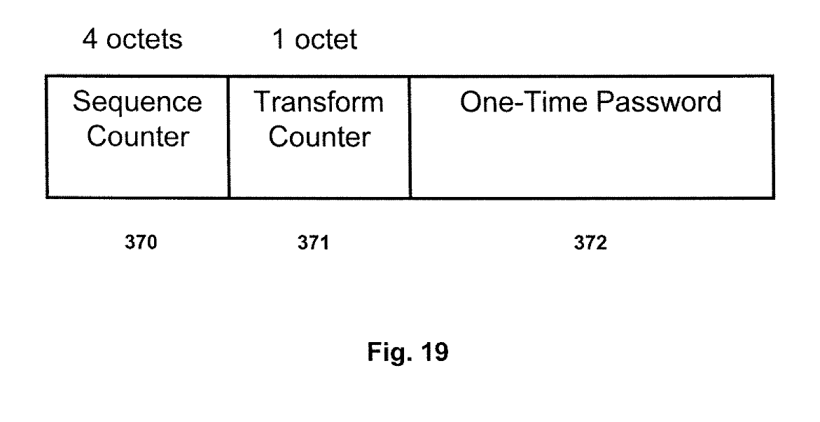

FIG. 19 shows an exemplary layout of auth data 207 field when the one-time password authentication method is used. Client computer 100 places its computed one-time password value, OTPₙ, in the one-time password 372 field, the SeqCntᵢ value into the sequence counter field and the TrfCountᵢ value in the transform counter field.

In still another embodiment, the authentication method used to authenticate client computer 100 to server computer 101 is based on public key cryptographic methods. In one embodiment, client computer 100 encrypts the sequence number field, Seq#, from the TCP header in SYN packet 200 which it is preparing for transmission to server computer 101, with client computer 100 private key, Pr v^{C}:

E_{Prv}_{^{C}}(Seq#)

Upon receiving SYN packet 200 from client computer 100, server computer 101 decrypts the Seq# value using client computer 100 public key, Pub^{C}:

Seq#=D_{Pub}_{^{C}}(E_{Prv}_{^{C}}(Seq#))

Server computer 101 verifies that the sequence number, Seq#, contained in auth data 207 field is the same as the sequence number value found in the sequence number field of SYN packet 200 sent by client computer 100 to server computer 101.

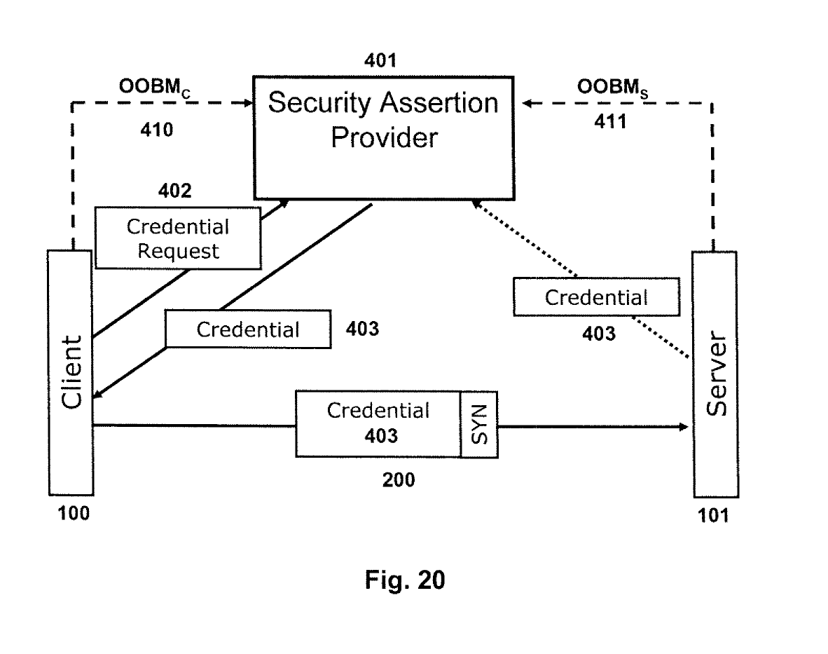

FIG. 20 illustrates another embodiment in which the authentication method used to authenticate client computer 100 to server computer 101 is based on the presence of a trusted security assertion provider. In one embodiment, server computer 101 and client computer 100 establish a trust relationship with a security assertion provider 401 entity. This trust relationship is established via some out-of-the-band methods OOBM_{C} 410 and OOBM_{S} 411.

When client computer 100 wishes to establish a new TCP/IP communications session with server computer 101, it sends to security assertion provider 401 a credential request 402 to ask for the issuance of an authentication credential. Security assertion provider 401 issues client computer 100 an authentication credential such as, without limitation, an authentication token, a digital certificate or a Kerberos ticket. Security assertion provider 401 forwards this issued credential 403 to client computer 100.

Upon receiving credential 403 from security assertion provider 401, client computer 100 embeds the credential 403 in SYN packet 200 and sends this packet to server computer 101.

When server computer 101 receives SYN packet 200, it extracts credential 403. Depending on the type of credential 403, server computer 101 verifies it, without limitation, locally, with security assertion provider 401 or any other trustworthy entity capable of verifying credential 403.

Password-based authentication may be used in one embodiment as the authentication method used to authenticate client computer 100 to server computer 101. Client computer 100 incorporates a password in SYN packet 200.

Upon receiving SYN packet 200 sent by client computer 100, server computer 101 compares the received password value with a locally stored value and accepts the connection if password values match.

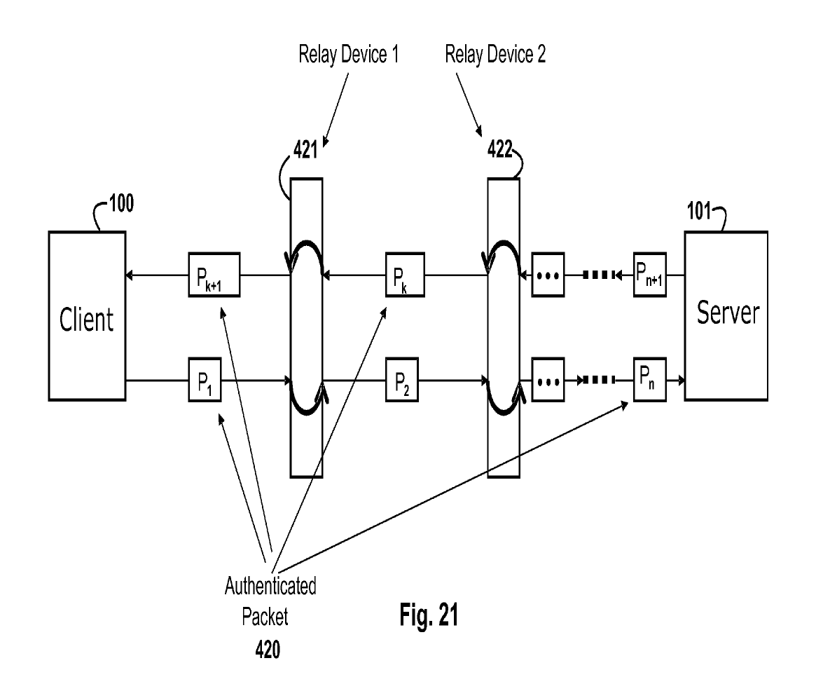

FIG. 21 illustrates another embodiment in which the authentication method used to authenticate client computer 100 to server computer 101 is based on the presence of one or more intermediary communication nodes, relay devices 421-422, each of which relays authenticated packets 420 sent between client computer 100 and server computer 101.

In this embodiment, an authenticated packet 420, P₁, sent by client computer 100, is authenticated for acceptance by the next relay device 421. After authenticating the packet relay device 421 modifies or replaces authentication information in the packet with its own authentication information and forwards this modified authentication packet, P₂, to the next relay device 422, etc. Finally, authenticated packet 420, Pₙ, (a packet whose authentification information has been modified n−1 times before the packet reaches server computer 101) reaches server computer 101.

Upon receiving and verifying authentication information in authenticated packet 420, Pₙ, server computer 101 transmits the acceptance packet through the same or an alternative chain of relay devices 421-422.

Client computer 100 and/or server computer 101 may be any kind of computer, wireless devices, personal digital assistants (PDAs), laptop computers, phones or other communication devices or combinations thereof.

Furthermore, in one embodiment, client computer 100 is authenticated against a database of hosts stored in a computer readable memory. In such a case, peers being authenticated may have been registered before connection establishment was attempted. This memory may be part of server computer 101 or accessible thereby. In one embodiment, the authentication technique described herein is integrated with enterprise security systems, such as, for example, RADIUS (Remote Authentication Dial-In User Service), Windows Domain, etc., to determine valid peers.

In one embodiment, such a process in which authentication of registered peers may be performed includes accessing a memory storing a list of one or more valid peers, comparing the prospective peer with the list of one or more potentially valid peers and the data used to authenticate them to determine if the prospective peer is in the list, and authenticating the prospective peer if determined to be on the list. The data used to identify the peer is in the SYN packet. After a particular peer is determined to be valid, a server, such as server 101 described above, may use other information, such as, for example, the encrypted information or other forms of information described above in the SYN packet, to determine whether the prospective peer is who they say they are.

FIG. 22 shows a block diagram of an exemplary computer which may be used with an embodiment of the invention. For example, system 800 shown in FIG. 22 may used as hosts to form a secure subnetwork within a general purpose network, such as front end servers 701, middleware servers 702, or backend servers 703 of FIG. 2. Note that while FIG. 22 illustrates various components of a computer system, it is not intended to represent any particular architecture or manner of interconnecting the components, as such details are not germane to the embodiments of the present invention. It will also be appreciated that network computers, handheld computers, cell phones, and other data processing systems which have fewer components or perhaps more components may also be used with the embodiments of the present invention. Further detailed information with respect to establishments of an authenticated network connection can be found in the co-pending application Ser. No. 10/224,098, entitled “Establishing Authenticated Network Connection”, filed Aug. 19, 2002, now U.S. Pat. No. 7,069,438, which is hereby expressly incorporated by reference.

As shown in FIG. 22, the computer system 800, which is a form of a data processing system, includes a bus 802 which is coupled to a microprocessor 803 and a ROM 807, a volatile RAM 805, and a non-volatile memory 806. The microprocessor 803, which may be a Pentium processor from Intel Corporation, is coupled to cache memory 804 as shown in the example of FIG. 22. The bus 802 interconnects these various components together and also interconnects these components 803, 807, 805, and 806 to a display controller and display device 808, as well as to input/output (I/O) devices 810, which may be mice, keyboards, modems, network interfaces, printers, and other devices which are well-known in the art. Typically, the input/output devices 810 are coupled to the system through input/output controllers 809. The volatile RAM 805 is typically implemented as dynamic RAM (DRAM) which requires power continuously in order to refresh or maintain the data in the memory. The non-volatile memory 806 is typically a magnetic hard drive, a magnetic optical drive, an optical drive, or a DVD RAM or other type of memory system which maintains data even after power is removed from the system. Typically the non-volatile memory will also be a random access memory, although this is not required. While FIG. 22 shows that the non-volatile memory is a local device coupled directly to the rest of the components in the data processing system, it will be appreciated that the embodiments of the present invention may utilize a non-volatile memory which is remote from the system, such as a network storage device which is coupled to the data processing system through a network interface such as a modem or Ethernet interface. The bus 802 may include one or more buses connected to each other through various bridges, controllers, and/or adapters, as is well-known in the art. In one embodiment, the I/O controller 809 includes a USB (Universal Serial Bus) adapter for controlling USB peripherals.

In conclusion, the present invention provides for low cost and highly efficient security safeguards for standard TCP/IP Servers deployed on private and public IP networks. A method for creating secure subnetworks on a general purpose network disclosed in this invention is based on the SNT technology. SNT is a combination of traditional security methods and an innovative standards-based approach to authenticating and protecting network traffic. SNT provides a wide variety of security options for establishing a secure data pipeline between servers, with the capability of authenticating each connection tunneled within this pipeline. SNT provides an authentication capability to back-end systems, which are otherwise incapable of authenticating themselves, to enable them to communicate with servers and other peers in a secure fashion.

SNT is a software solution and its deployment does not require installing any additional hardware. Since SNT is deployed in the IP stack, applications are unaware of its presence and keep running “as-is” without any changes. Due to SNT's point-to-point nature and its use of well-known technologies, there is no requirement for reconfiguring the network or for opening additional ports on interdepartmental firewalls. SNT may reduce the number of open firewall ports, because multiple application level protocols can be tunneled through a single secure pipe. With SNT, TCP/IP servers remain cloaked to all except authorized parties. Unauthorized parties cannot even identify open ports on the servers, and therefore cannot gain access.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

1-99. (canceled)

100. In a computer network of a plurality of network devices that is comprised of at least one source device, at least one destination device and at least one intermediate device, in which packets of information are communicable across said network in accordance with an industry standard communication protocol, a method of improving the security of at least a portion of the network, comprising the steps of:
receiving a packet of information by a first intermediate device;
introducing, modifying or replacing at least one credential in said packet of information, said at least one introduced, modified or replacement credential residing in a header portion of the packet formed in accordance with said industry standard communication protocol and containing information pertaining to said at least one source device that is supplemental to information required by said industry standard communication protocol;
enabling assessment of said at least one introduced, modified or replacement credential by a plurality of devices on said network downstream of said intermediate device; and
permitting said at least one source device to communicate with said at least one destination device conditioned upon the results of an assessment of said at least one introduced, modified or replacement credential by one or more of said plurality of devices.

101. The method as set forth in claim 117, wherein said assessing step comprises:
performing a security procedure to determine if said at least one introduced, modified or replacement credential is satisfactory for authentication or authorization in accordance with an authentication or authorization policy.

102. The method as set forth in claim 101, wherein said security procedure comprises an authentication procedure.

103. The method as set forth in claim 101, wherein said security procedure comprises an authorization procedure.

104. The method as set forth in claim 101, wherein said security procedure is performed by said a second intermediate device downstream from said first intermediate device.

105. The method as set forth in claim 101, wherein said security procedure comprises forwarding said packet of information if said at least one introduced, modified or replacement credential is satisfactory in accordance with said authentication or authorization policy and not permitting communication with respect to said packet to continue if said at least one credential is not satisfactory in accordance with said authentication or authorization policy.

106. The method as set forth in claim 101, wherein said at least one introduced, modified or replacement credential is in plain text.

107. The method as set forth in claim 101, wherein said at least one introduced, modified or replacement credential includes information that is relevant to the application of said authentication or authorization policy.

108. The method as set forth in claim 101, wherein said at least one introduced, modified or replacement credential is introduced or modified by said first intermediate device into multiple packets of information transmitted during a communication session.

109. An intermediate network device that is capable of improving the security of communication between a plurality of devices on a computer network that comprises a source device, a destination device, and said intermediate network device, comprising:
computer memory configured to store instructions for causing said intermediate network device to receive a packet of information over the network in accordance with an industry standard communication protocol that specifies that said packet of information comprise a header portion comprising required information comprising a network address of said source device and said destination device for said packet of information, and optional information supplemental to said required information;
computer memory configured to store instructions to enable said intermediate network device to introduce, modify or replace a credential in said header portion of said packet of information, said introduced, modified or replacement credential containing information pertaining to said source device that is supplemental to information required by said industry standard communication protocol and in a form assessable by a plurality of devices downstream of said intermediate device on said network;
computer memory configured to store instructions for assessing said introduced, modified or replacement credential in said packet; and
computer memory configured to store instructions for performing a security procedure concerning the authentication or authorization of said source device based upon said introduced, modified or replacement credential.

110. The network device as in claim 118, wherein said introduced, modified or replacement credential is in plain text.

111. The network device as in claim 118, wherein said introduced, modified or replacement credential includes information that is relevant to the application of at least one authentication or authorization policy.

112. The network device as set forth in claim 118, wherein said security procedure is an authentication procedure.

113. The network device as set forth in claim 118, wherein said security procedure is an authorization procedure.

114. The network device as in claim 118, wherein said introduced, modified or replacement credential is introduced or modified by said first intermediate network device in multiple packets of information transmitted during a communication session.

115. The network device as set forth in claim 118, wherein said at least one credential is replaced with a substitute credential introduced by said intermediate device into multiple packets of information transmitted during a communication session.

116. The method as set forth in claim 117, wherein said at least one introduced, modified or replacement credential is replaced with a substitute credential introduced by said first intermediate device into multiple packets of information transmitted during a communication session.

117. The method as set forth in claim 100, wherein said at least one introduced, modified or replacement credential resides in an optional portion of said header portion of the packet formed in accordance with said industry standard communication protocol.

118. The network device as in claim 109, wherein said at least one introduced, modified or replacement credential resides in an optional portion of said header portion of said packet formed in accordance with said industry standard communication protocol.
